(19) United States
(12) Patent Application Publication
(10) Pub. No.: US 2011/0209438 A1
(43) Pub. Date: Sep. 1, 2011

(54) METHOD OF MANUFACTURING COMPOSITE STRUCTURAL PANELS AND USING SUPERIMPOSED TRUSS MEMBERS WITH SAME

(76) Inventors: Petros Keshishian, Castro Valley, CA (US); Armen Martirossyan, Glendale, CA (US)

(21) Appl. No.: 13/037,308

(22) Filed: Feb. 28, 2011

Related U.S. Application Data
(63) Continuation of application No. 11/618,731, filed on Dec. 29, 2006, now abandoned.

(51) Int. Cl. E04C 2/34; E04C 3/02; B23P 17/00

(52) U.S. Cl. 52/790.1; 52/694; 29/897.32

(57) ABSTRACT

A method of producing an engineered composite structural panel by selecting a structural panel having at least two structural shells, an insulating material extending therebetween, and a plurality of truss members extending therebetween. A determination is made if the two or more structural shells act as a unitary composite structural panel. If the structural panel is not a unitary composite structural panel, then parameters of the panel are adjusted and it is further determined whether the panel is a unitary composite structural panel. Combined truss systems for strengthening the structural panels may be formed by combining ladder truss members with warren truss members, by superimposing the ladder truss members and warren truss members, and by superimposing ladder truss members with a warren truss member and another warren truss member that is inverted.

### RELATED APPLICATIONS

This application is a continuation of application Ser. No. 11/618,731, filed on Dec. 29, 2006, and therefore claims the benefit of priority thereof.

### FIELD OF THE INVENTION

The present invention generally relates to the field of structural panels and more specifically to improved truss members for use with such panels and a method of manufacturing panels using an engineered approach.

### BACKGROUND OF THE INVENTION

Structural Concrete Insulating Panels (SCIP) are typically composed of two or more structural shells that are separated with an insulating material and connected via steel trusses. In a typical SCIP panel, the shells are fabricated from concrete, the insulating material is a foam and the trusses are composed of wire. Such SCIPs are used in building homes and other structures by relatively unskilled laborers and are pre-fabricated and sent to the jobsite. SCIP panels are advantageous in that the same type of panel may be used to erect walls, floors, ceilings and other panels of a building by relatively unskilled laborers, provides good insulation, and may be produced with environmentally friendly materials. Disadvantageously, the cost of implementing SCIPs can become high due to costs associated with meeting building code requirements and manufacturing costs. The present invention addresses those needs in the art.

Building code requirements typically require SCIPs to obtain an International Council of Building Officials “ICBO” number (now called International Code Council “ICC”) that involves a series of laboratory tests to test the structural capacity of the panel or per local building department requirements' separate research report. This is because the SCIPs are not classified as a standard item by the building codes. In obtaining the ICBO number, SCIP manufacturers were typically required to submit their panels for laboratory testing and through a series of trial and error by applying loads upon the panel to test the critical capacity and otherwise determine the structural properties of the panel based on the dimensions of a few panels. Such a process is time consuming and costly for the manufacturer and until now, it is understood that this was the only way to allow a SCIP panel to pass the building code requirements.

In designing a SCIP, it must be determined how the two rigid shells that make up the panel will react when under load. In a first case, each rigid shell is treated as a separate shell member such that each shell will fail individually when a load is placed upon it that exceeds the capacity. In a second case, the system of both rigid shells acting together will fail as one composite section. In making such a determination, it is the objective to design a SCIP that will fail as one composite section because such a design will yield a significantly higher capacity when under load. It is understood that there is no currently developed methodology for allowing a SCIP designer to make this determination without undergoing laboratory tests. This critical determination is key to designing a SCIP that constitutes a composite section.

By approaching the design of a SCIP from an engineering perspective, there is a long felt need in the art for determining whether the SCIP acts as a single composite panel and for providing a theoretical method of designing such SCIPs that conform to building code requirements without the necessity of undergoing expensive laboratory testing.

A typical truss employed in a SCIP is one that is made up of a rod which is formed in a zigzag configuration between two parallel rods with an angle of approximately 30 degrees. This is known as a warren truss. While warren trusses are well known in their ability to provide strengthening, their application to SCIPs suffers from drawbacks that ultimately result in SCIPs which cannot handle large capacities and can be improved upon.

For example, U.S. Pat. No. 6,718,712 discloses pre-fabricated structural panels and a method of fabrication, which utilizes commercially available panel components, such as trusses, fillers, wire meshes, and metal ties; filler material of stabilized organic material such as biomass or agricultural waste; and fabrication of such panels with varying thickness.

Disadvantageously, the '712 patent uses only a warren truss with an approximate 30 degree angle which is relatively inefficient and uneconomical for panel construction.

Even further, the '712 patent fails to provide a method of engineering the sizes, weights, strengths, spacing and composition of various panel components, particularly those for concrete panel skins, by applying an engineering approach to determining whether the panel acts as a composite structural panel prior to designing the panel.

### SUMMARY OF THE INVENTION

The present invention provides a improved method of designing and manufacturing a panel that is a composite structural panel. More specifically, while it is understood that SCIPs all well known in the art and can be manufactured according to a variety of different ways, the current problem is that from an engineering perspective, there is no known methodology for designing a SCIP having two or more structural shells where the entire SCIP acts as a unitary composite structural panel. The present invention addresses that need by providing a novel method of designing such a panel to determine whether the panel is indeed a composite panel, determining the capacity of that panel, and adding additional structure if necessary to make the panel act as a unitary composite structural panel. It should be recognized that the novel process of making this determination is not limited to the panel illustrated and described but is also applicable to other structural concrete panels so long as they share the same characteristics of having at least two shells joined by a truss or other strengthening device. It is also not critical to incorporate the additional truss systems herein to practice the novel process described herein.

By adopting the test approval method the manufacturer is only limited to producing the size and configuration panels that it has tested. This limits the different panel configurations that one can manufacture due to the cost and time limitation of testing and getting approval on any single size and configuration panel. The present invention provides the manufacturer with the ability to produce panels of any size and configuration so long as it meets the general category of SCIP, without undergoing testing-based approval.

Specifically, a panel having two or more structural shells joined by a series of trusses or other types of connections suffers from the problem that inadequate parameters will cause one of the structural shells to fail independently of the other when excess loads are placed thereupon. In that respect, a panel designed having such individual structural shells is a weaker panel that if the two or more structural shells are joined by the trusses but act as one cohesive unit, or a unitary structural shell. Such a unitary structural shell will have a set capacity and will truly act as one cohesive unit such that excess loads placed upon the entire panel dictate the failure rate of the panel, not the loads placed upon the individual structural shells. The engineering theory developed herein provides a methodology for establishing that the individual structural shells are indeed sufficiently connected by the trusses and overall act as one cohesive unit. Once establishing that the panel acts as a unitary structural shell, standard engineering principals may be applied to determine the total capacity of the panel, which is greater than if the individual structural shells were configured to independently fail when excess loads are placed thereupon.

To further ensure that the panel works as a unitary structural shell, at least three types of truss systems may be attached to the panel to strengthen the bond between the individual structural shells. Those truss systems include a first truss system whereby a conventional and commercially available ladder truss may be superimposed upon an additional truss having a rod extending between two parallel rods in a zigzag configuration, which is also known as a warren truss. Preferably, the ladder and warren trusses are superimposed upon each other such that the angle bends of the warren truss interest with the ladder truss bars.

A second type of truss system is similar to the first truss system but includes the addition of a second warren truss that is inverted and superimposed upon both a ladder truss another warren truss.

In a third type of truss system, no superimposing is necessary, and instead a combined truss system is developed which integrates both the rod having a zigzag configuration from a warren truss with the ladder truss in one integral unit.

These three truss systems are advantageous in that they provide enhanced strengthening between the structural shells and further ensure that the panel globally acts as unitary composite structural shell.

### BRIEF DESCRIPTION OF THE DRAWINGS

FIG. 1 is a perspective view of a SCIP having a combined truss member attached thereto;

FIG. 2 is a elevational view of a combined truss;

FIG. 3 is a elevational view of a ladder truss;

FIG. 4 is a view illustrating the combination of a ladder truss with a warren truss;

FIG. 5 is a view of a ladder truss combined with a first warren truss and an inverted second warren truss;

FIG. 6 is a diagram illustrating buckling as a result of the shells acting individually;

FIG. 7 is a diagram illustrating buckling as a result of the shells working together as a unitary composite structure shell;

FIG. 8 is a P-M interaction diagram;

FIG. 9 illustrates the applied load P, its eccentricity e, the compressive capacity of a shell Fc, the tensile capacity of a shell Ft, and the parameters of the panel;

FIG. 10 is a key to notation variables used in the exemplary calculation according to the present invention for a wall;

FIG. 11 illustrates the truss combinations of the warren truss, a first truss system and a third truss system, and additional sets forth the material properties for the panel;

FIG. 12 sets forth the variables used the calculations and illustrates the parameters which may be varied to determine if the panel is a unitary composite structural panel;

FIG. 13 illustrates the selected truss system and calculations required for buckling capacity between truss connection points and to determine whether the panel is a unitary composite structural panel;

FIG. 14 is a continuation of FIG. 13 and illustrates further calculations for determining whether the panel is a unitary composite structural panel;

FIG. 15 provides calculations for an exemplary calculation accounting for seismic or wind shear and gravity;

FIG. 16 provides out-of-plane loading calculations;

FIG. 17 is a continuation of FIG. 16 and further provides calculations accounting for eccentricity;

FIG. 18 provides calculations for various load combinations and calculations accounting for shear capacity;

FIG. 19 provides calculations accounting for in-plane bending and out-of-plane capacity;

FIG. 20 is a continuation of FIG. 19 and further provides out-of-plane capacity calculations;

FIG. 21 provides calculations accounting for buckling of the compressed shell and gravity load demand including a P-M interaction diagram;

FIG. 22 is a continuation of FIG. 21 and further provides the P-M interaction diagram and also provides calculations accounting for shear capacity;

FIG. 23 provides calculations accounting for ladder truss buckling and concrete shell capacity to transfer shear between trusses;

FIG. 24 is a continuation of FIG. 23 and additionally provides calculations accounting for ladder truss wire punching-shear capacity; and

FIG. 25 provides calculations relation to warren truss wire pullout capacity and limitations on reinforcement ratio.

### DETAILED DESCRIPTION OF THE PREFERRED EMBODIMENT

Referring now to the drawings wherein the showings are for purposes of illustrating preferred embodiments of the present invention only, and not for purposes of limiting the same,

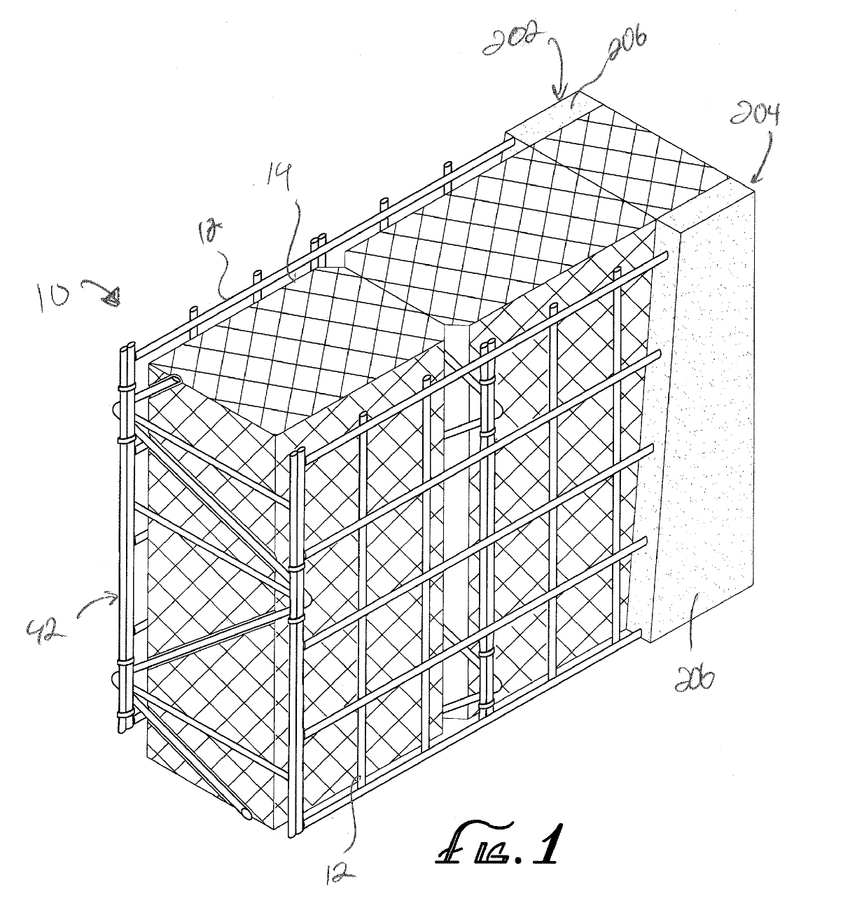

The first step in manufacturing a composite structural panel according to the present invention is selecting a structural panel having at least two structural shells, an insulating material therebetween, and a plurality of truss members extending therebetween. Preferably, the structural shells 202 and 204 are fabricated having wire-mesh and it is understood that such shells are later coated with a shotcrete cement layer 50 as shown in FIG. 1. It is then determined whether the two or more structural shells 202 and 204 act as a unitary composite structural panel as illustrated in FIG. 7. If after calculations it is determined that the structural panel 10 is not a unitary composite structural panel, then parameters are adjusted and calculations are performed again. Preferably, the parameters adjusted include spacing between the truss members, number of truss members, thickness of truss members, thickness of shells, and distance between shells.

Next, the engineering process continues by calculating the critical stiffness of the truss members when connected to the rigid layers to determine if the structural panel is a composite structural panel. The objective of this step to is determine whether the individual rigid layers are acting as a composite section. Using equilibrium equations applied to the system (including both rigid layers), and principles relating to the strength of materials, one is able to design a SCIP that conforms to current design code standards.

To better illustrate the theory, there are two criteria that define multiple shell structures being connected through steel wires are acting as a unitary composite structural panel or not.

Referring now to FIGS. 6-7, for Criterion 1, the following formula controls P_{Global}>P_{Local} and for Criterion 2, the following formula controls V_{Truss}>Vᵤ.

For Criterion 1, P_{Global} is the buckling capacity of the each shell 202 and 204 in global buckling mode between two supporting points 200 and 201 as shown in FIG. 6. The support points are the top and bottom floors for the walls, and the supporting walls for the slabs. P_{Global} is calculated based on the theory of beams of elastic foundation, where the stiffness of the elastic foundation is equivalent to the truss stiffness that is restraining the shell in the out of plane direction. P_{Local} is the buckling capacity of the each shell 202 and 204 in local buckling mode between neighboring points that connects the trusses 206 to the shells 202 and 204, as shown in FIG. 7.

Based in the theory of the strength of materials it is easy to show that if the out of plane stiffness of the trusses 206 is negligible than P_{Global}<P_{Local}. As the out of plane stiffness of the trusses 206 the global buckling capacity, P_{Global}, increases whereas the local buckling capacity, P_{Local}, is not affected.

The panel 10 will behave as comprised of single composite section when the out of plane stiffness of the trusses 206 reaches to the points that P_{Global}>P_{Local}.

The critical truss stiffness can be found by setting P_{Global}=P_{Local} Local for each shell 202 and 204 and solving for the critical out of plane truss stiffness for each shell. The critical out of plane stiffness will be the maximum stiffness found for all shells 202 and 204 that comprise the panel 10.

More practical approach is to check whether the given section is a composite section or not. To do so one has to compute the global buckling capacity, P_{Global}, and the local buckling capacity, P_{Local}, for each shell that comprises the panel and make sure that for each shell 202 and 204 P_{Global}>P_{Local}.

In Criterion 2, V_{Truss} is the shear capacity of the interconnecting trusses 206 between shells 202 and 204, and Vᵤ is the shear force applied to the panel 10 due to external loads.

In the event that pure bending is present, where the panel 10 has only parallel structural shells and is only exposed to loads that are inline with the structural shells, then check that the panel is a unitary composite structural shell. Through this iterative process, modify the parameters and re-check until the panel is confirmed as being a unitary composite structural shell. Then, for structural panels having more than two shells, calculate the stress-strain relationship for each individual structural shell both in tension and compression. Then, proceed by defining the ultimate limit states in tension and compression on the stress-strain relationship for each individual structural shell. Once it is determined that the shells act as a unitary composite structural shell, calculate all possible pairs of force and eccentricity where at least one of the shells exceeds the ultimate limit state. The limit state surface defining the capacity of the panel is defined by the possible set of all points that are defined by limiting force multiplied by the eccentricity defining the abscissa of the limit surface and the limiting force defining the ordinate of the limit state surface. This is more particularly shown in the P-M interaction diagram in FIG. 8.

If the panel is exposed to transient loading, i.e. loading upon the panel that is not parallel to the shells and/or the shells are not parallel to each other, then plane shear capacity should also be checked. It should be assumed in this instance that all shear is resisted by the trusses that connect the shells, unless it can be shown otherwise. However, panels 10 that have shells 202 and 204 connected to each other by concrete ribs can be excluded from this check, such as roof panels that are cantilevered a short distance and have a concrete rib at an edge thereof connecting the individual shells of the panel together.

Shear capacity of the trusses should be calculated based upon strength of materials and requirements of applicable building codes.

Truss connections should also be checked for pullout capacity and punching shear.

Referring now to FIG. 1, an exemplary structural panel 10 is illustrated as made according to the present invention. The panel 10 includes a wire mesh panel 12 on each side of the panel 10 and when covered in cement, becomes hardened and collectively create the shells 202 and 204. An insulating material 14, preferably foam, is provided and sandwiched between the shells 202 and 204. A third truss system 42 is attached to the panel 10

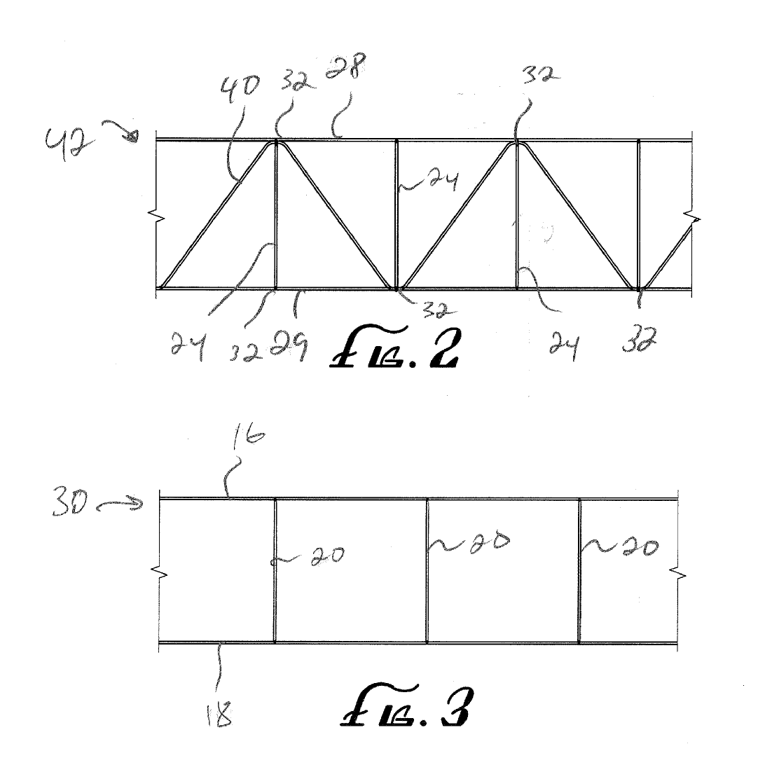

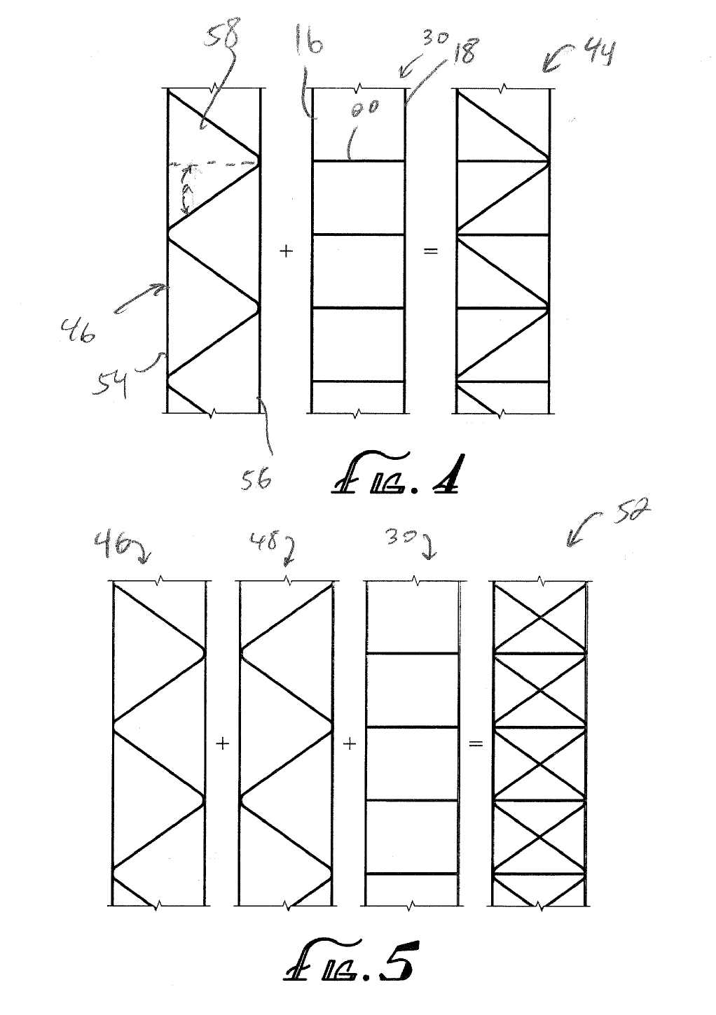

Referring now to FIGS. 2-5, first, second, and third truss systems made according to the present invention are illustrated which help strengthen the panel 10 and specifically strengthen the connection between the shells 202 and 204 to create a unitary composite structural shell. Referring now to FIG. 3 a ladder truss 30 is illustrated designed to be used with a structural panel 10 having a pair of wire-mesh panels 12 connected to and separated by an insulating material 14 extending therebetween. A pair of elongated parallel combined truss bars 16 and 18 and a plurality of elongated ladder bars 20 and 22 extend therebetween in perpendicular relationship to the combined truss bars 16 and 18 to form a ladder configuration.

Referring now to FIG. 2, a third truss system 42 that combines a warren and ladder truss is illustrated. A pair of elongated parallel combined truss bars 28 and 29 and a plurality of ladder bars ladder bars 24 extend therebetween in perpendicular relationship to the combined truss bars 28 and 29 to form a ladder configuration. An elongated zigzag bar 40 extends between the ladder bars 24 and 26. The ladder bars 24 and 26 and the zigzag bar 40 intersect each other at spaced-intervals along the combined truss bars 28 and 29 and being attachable to a portion of the structural panel 10 to form a unitary composite structural panel. Preferably such intersections 32 are equally spaced.

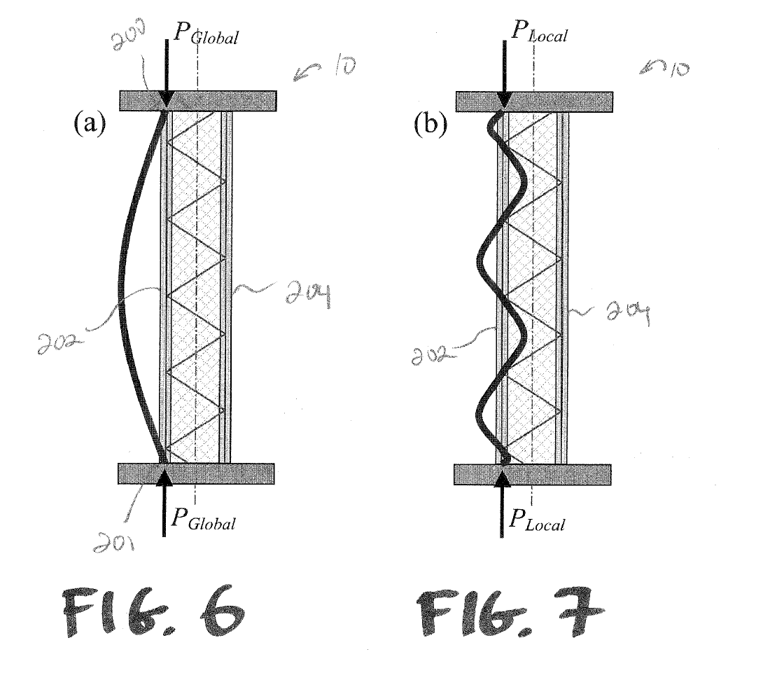

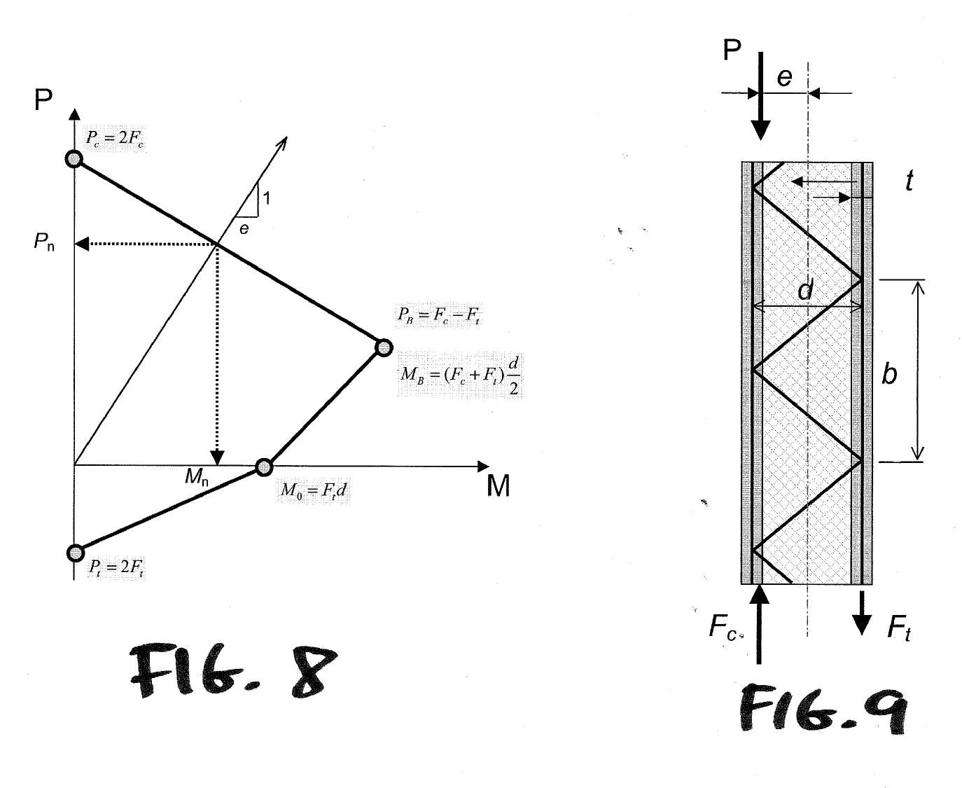

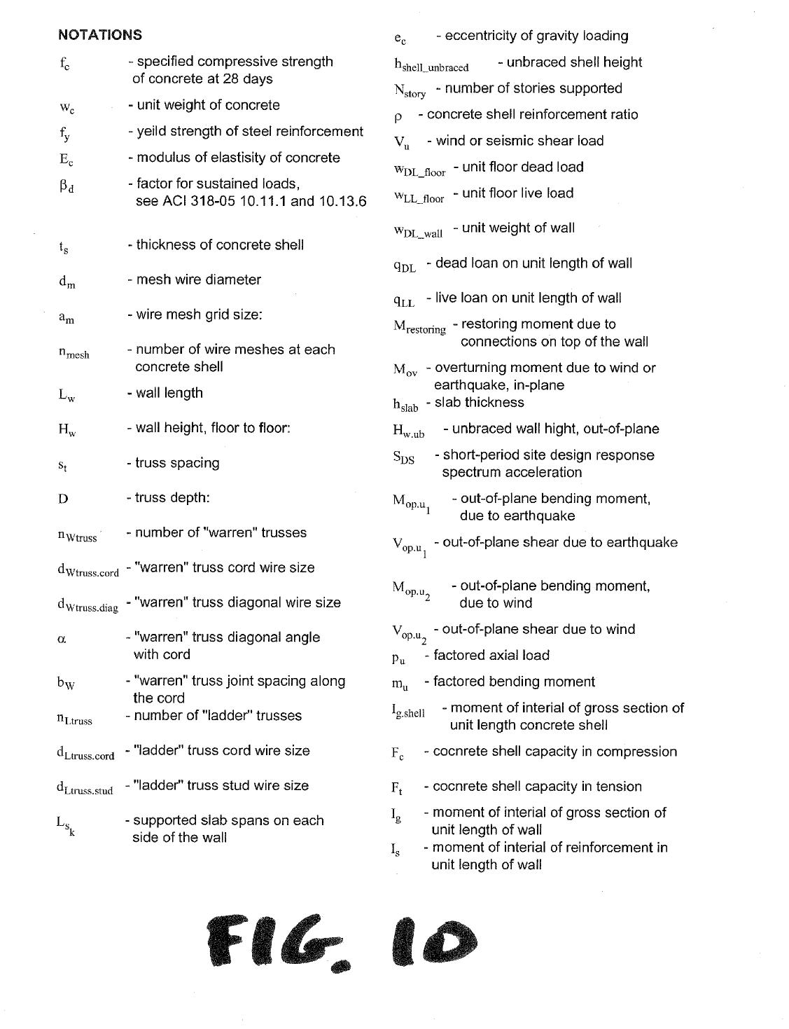

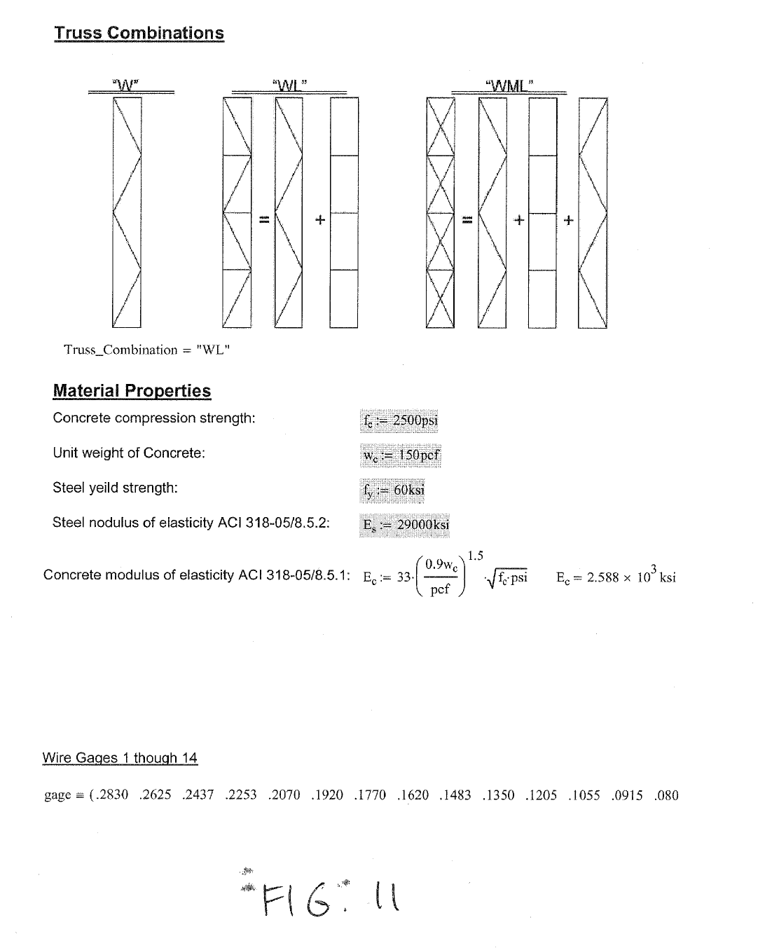

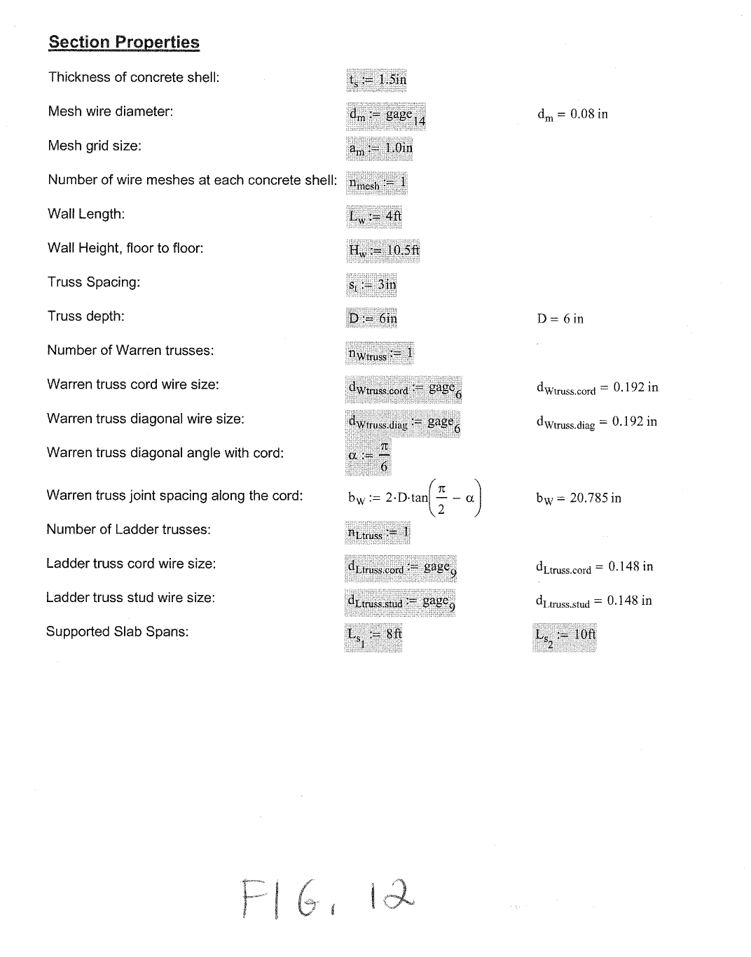

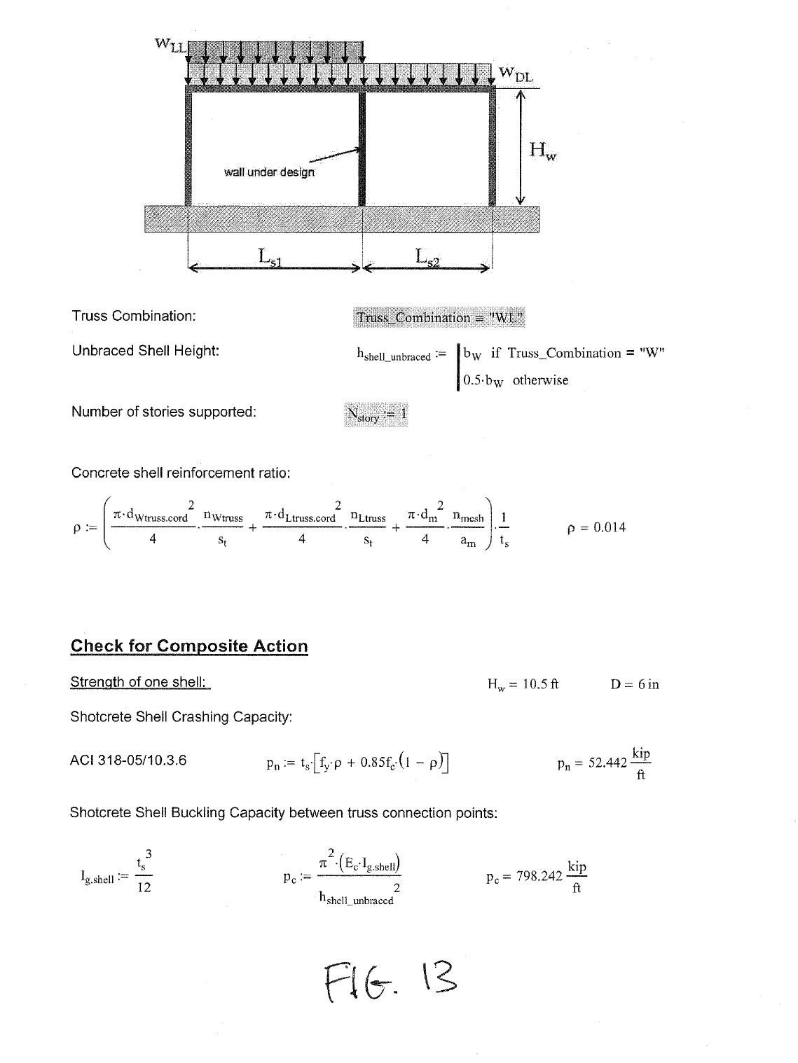

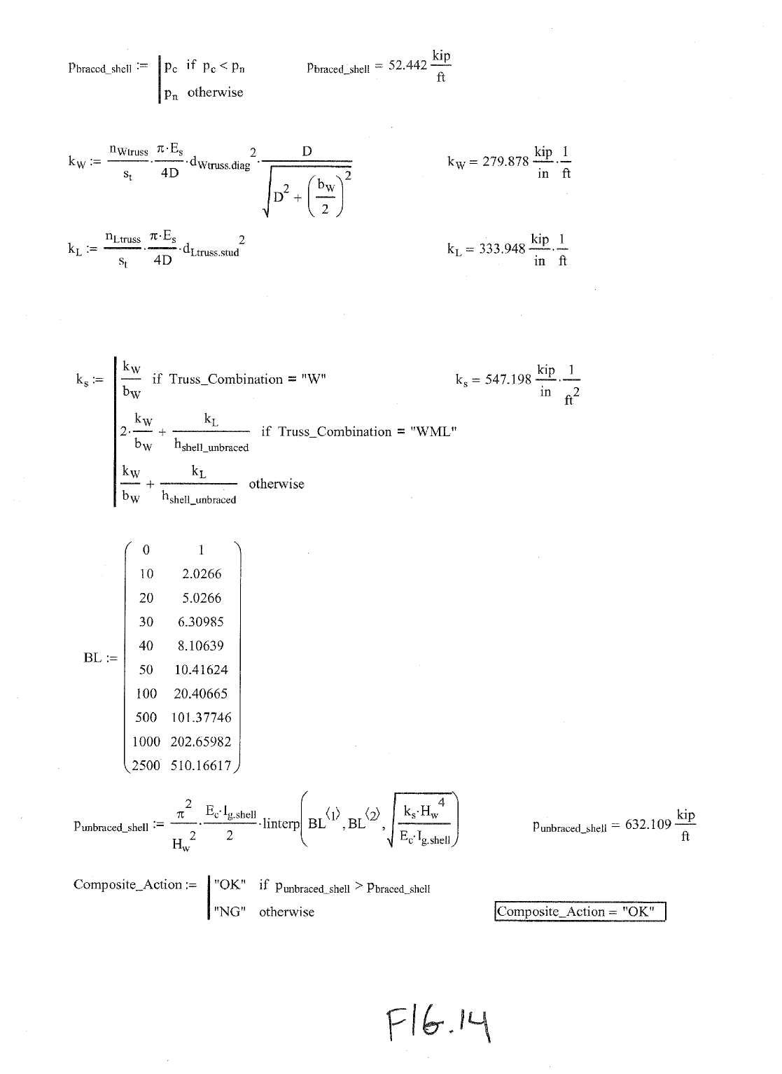

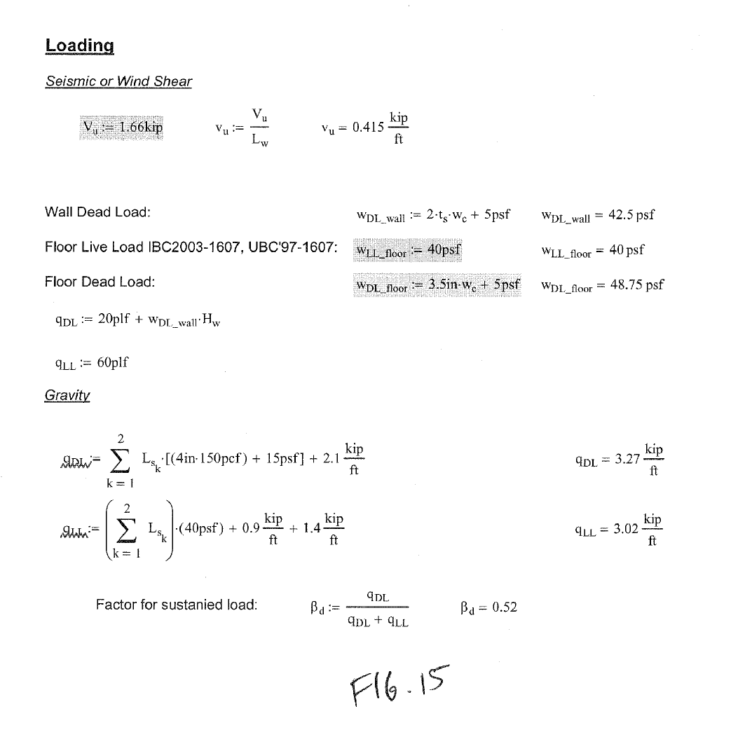

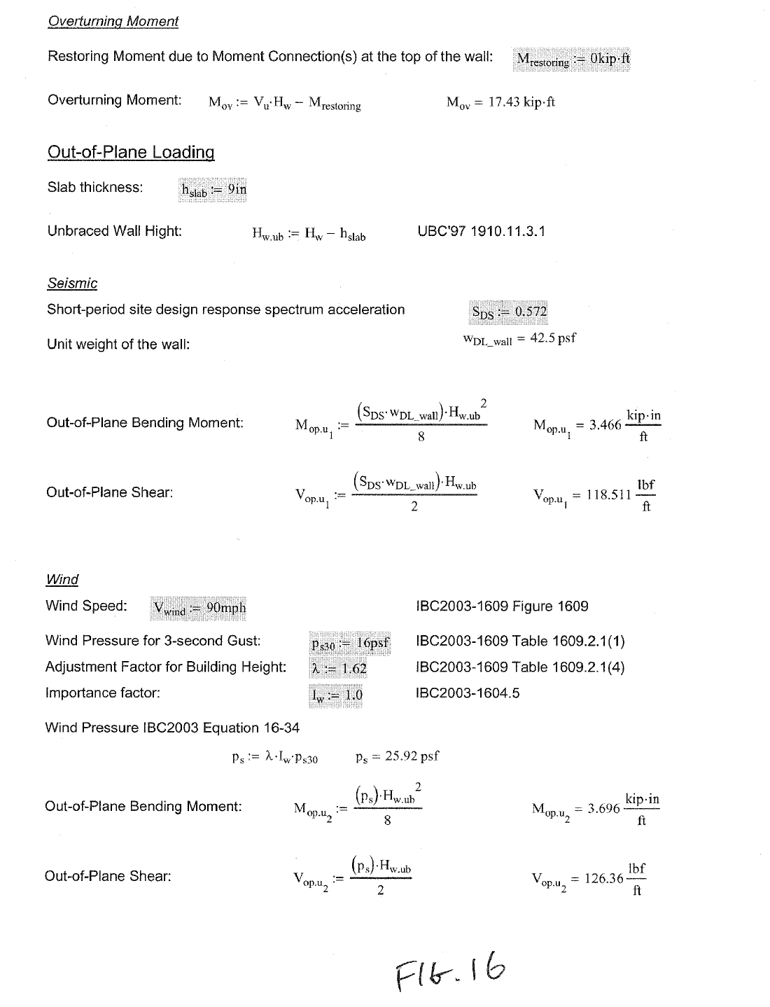

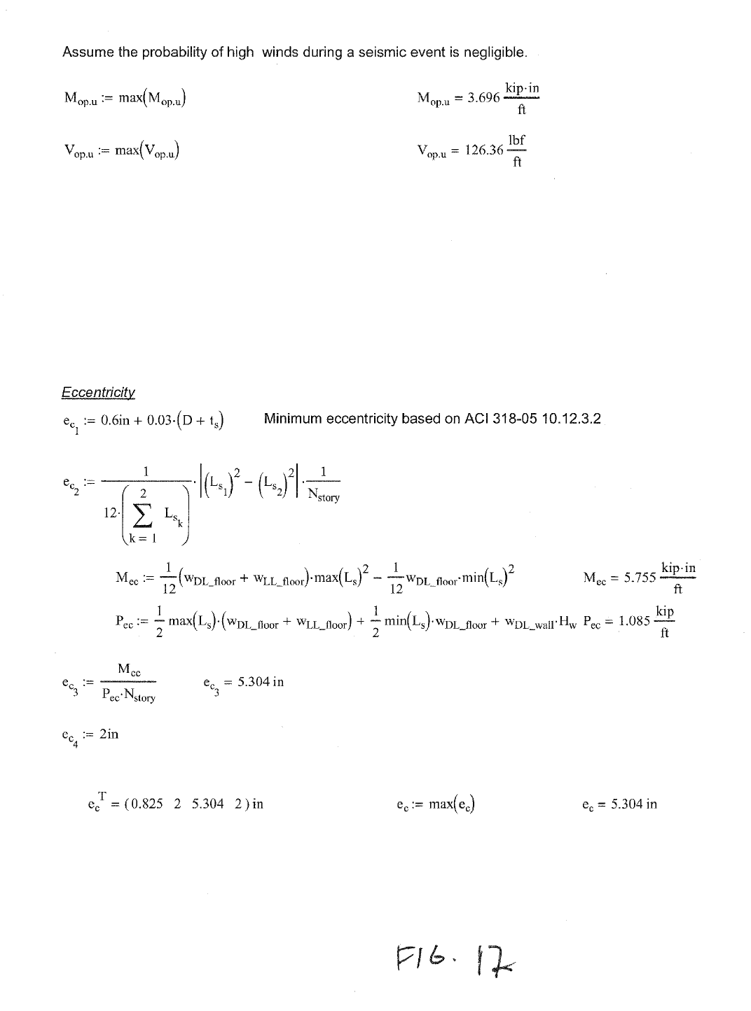

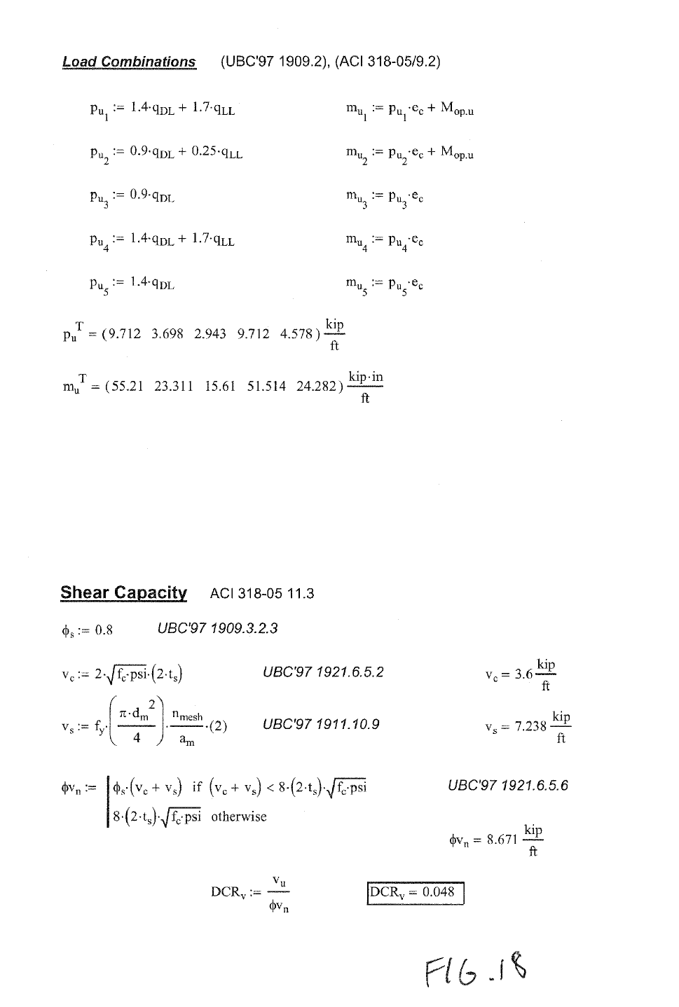

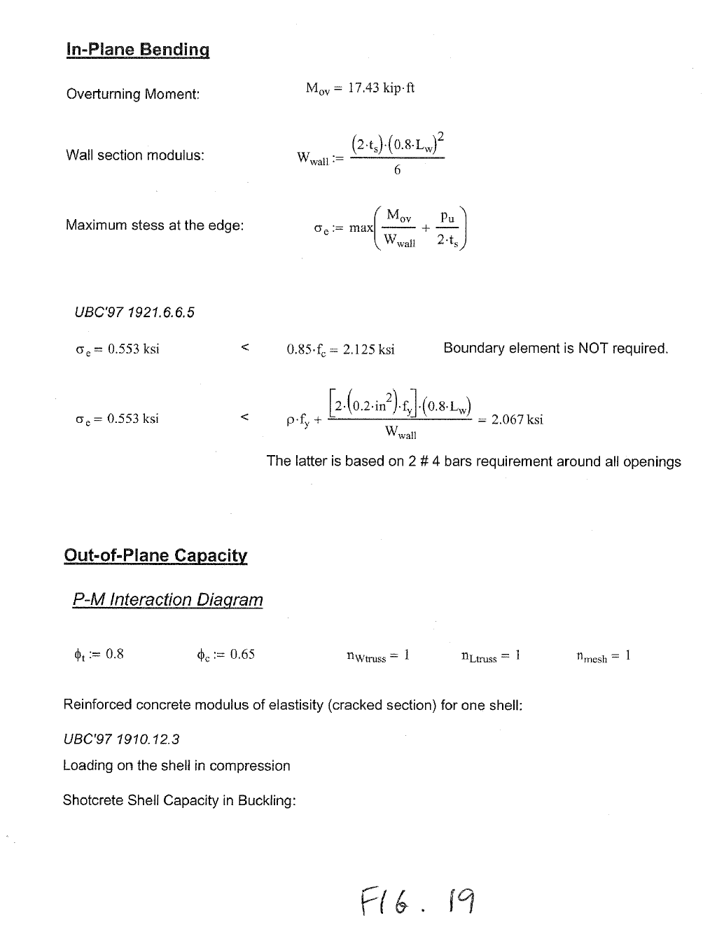

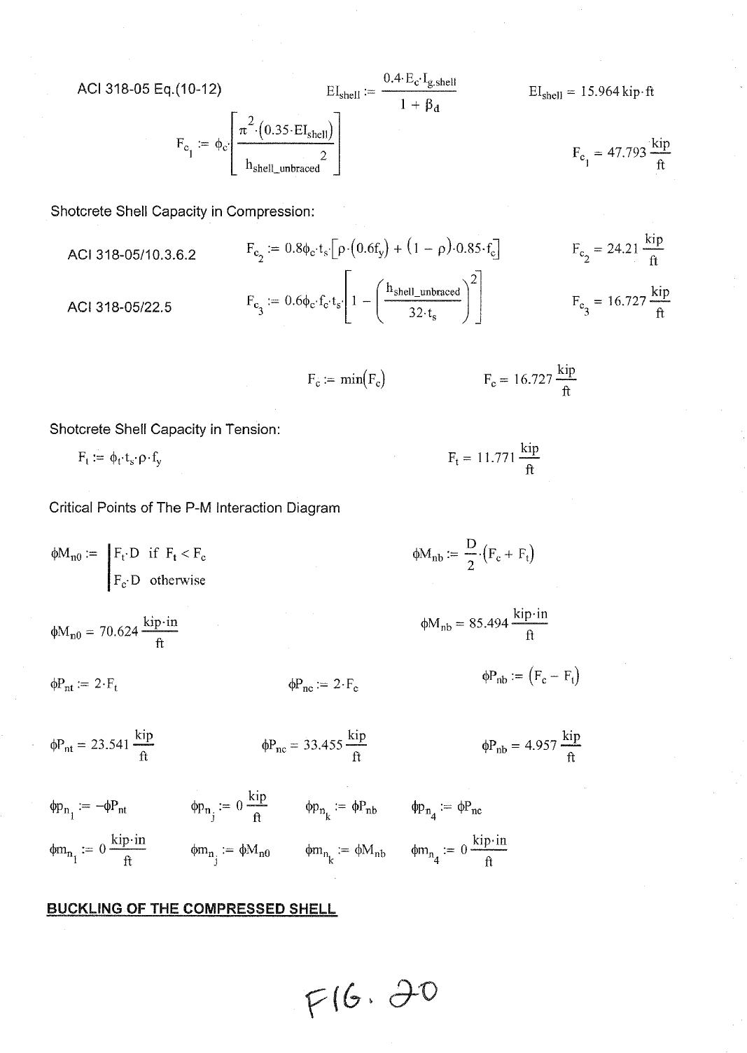

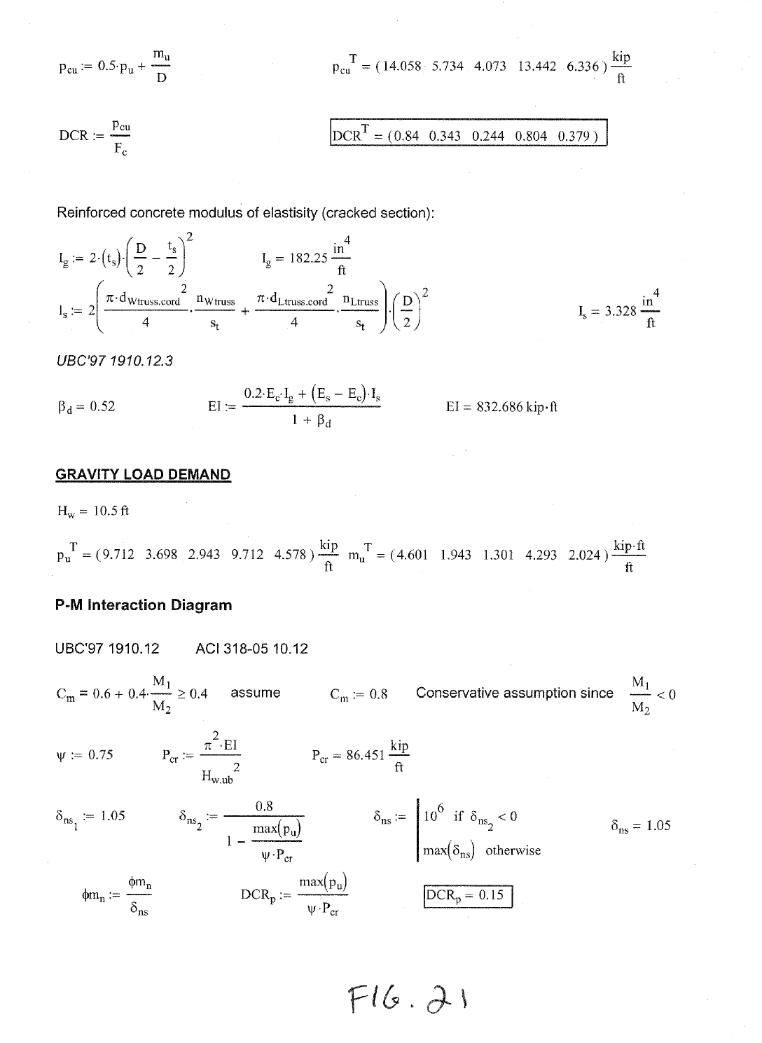

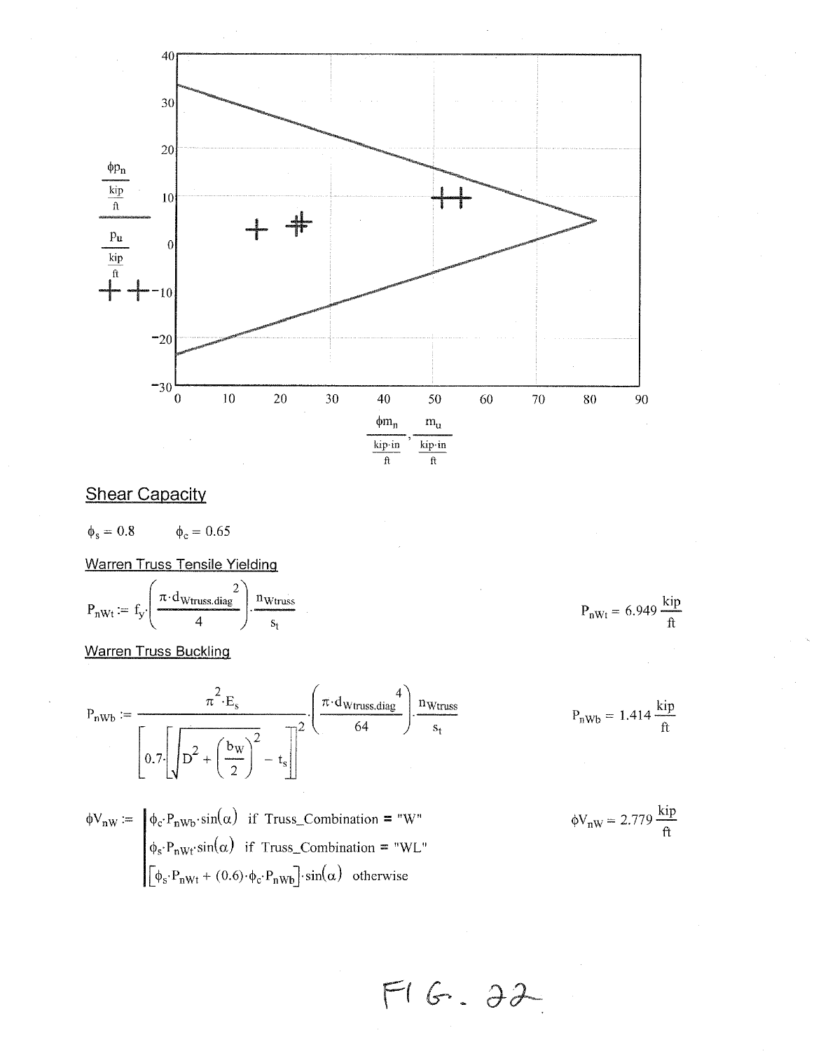

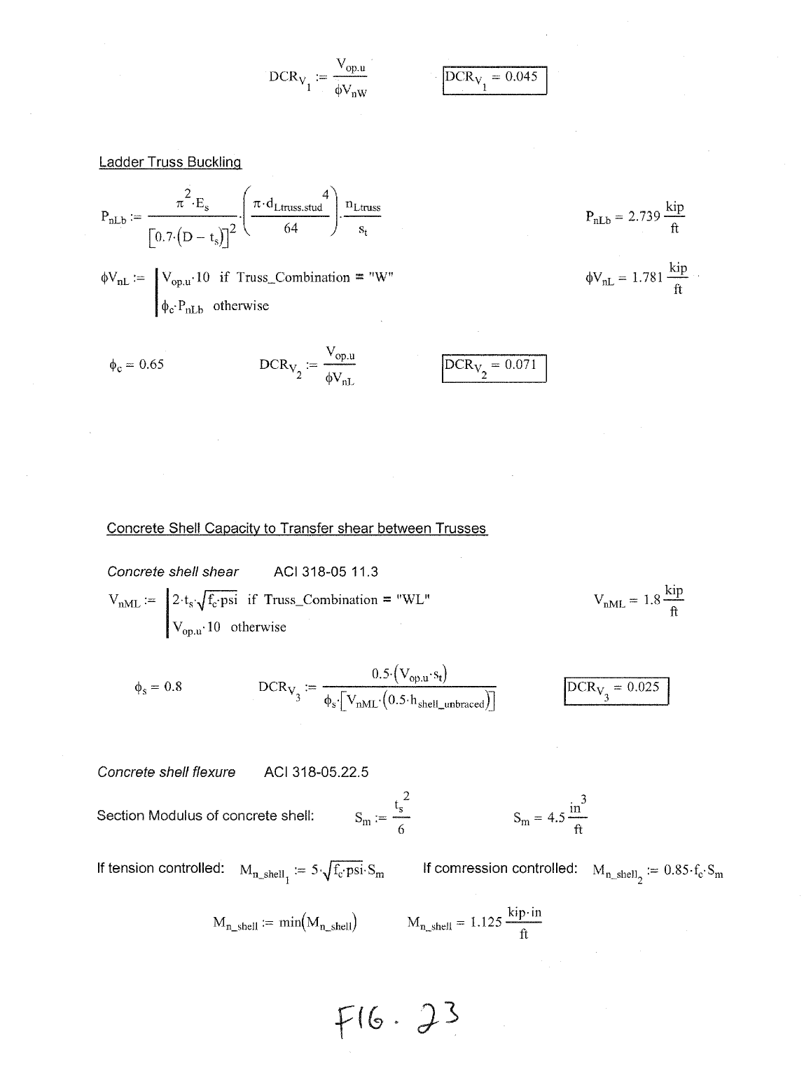

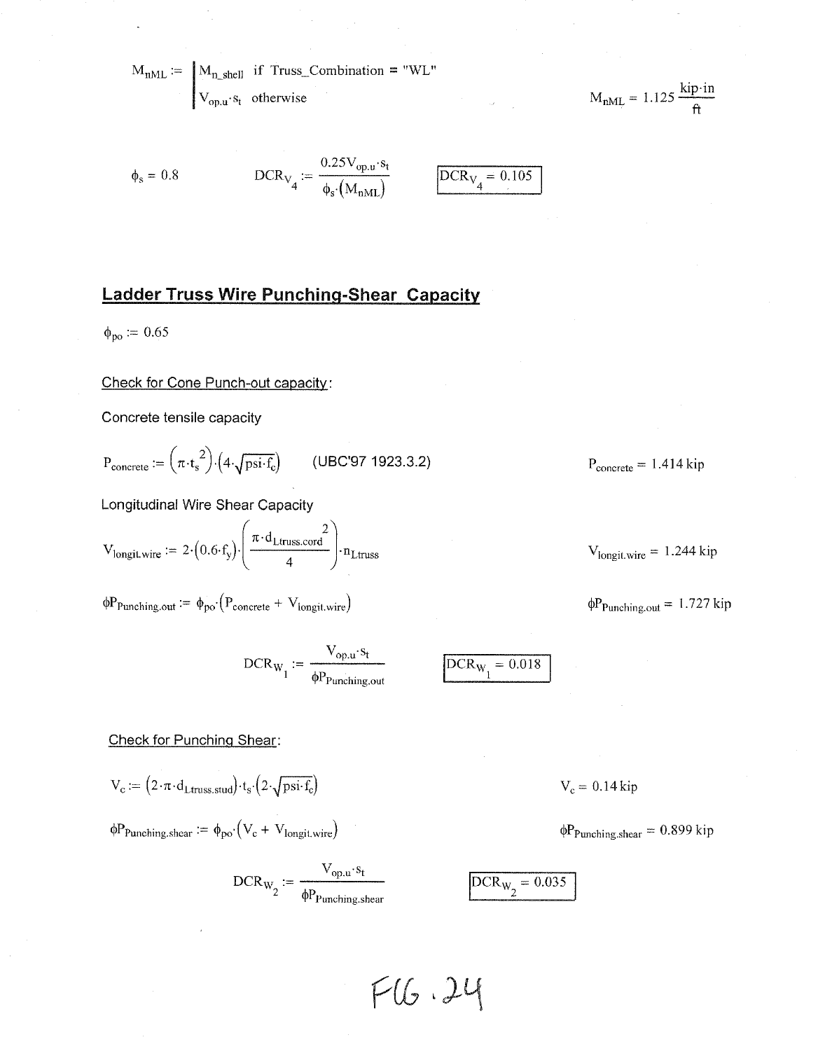

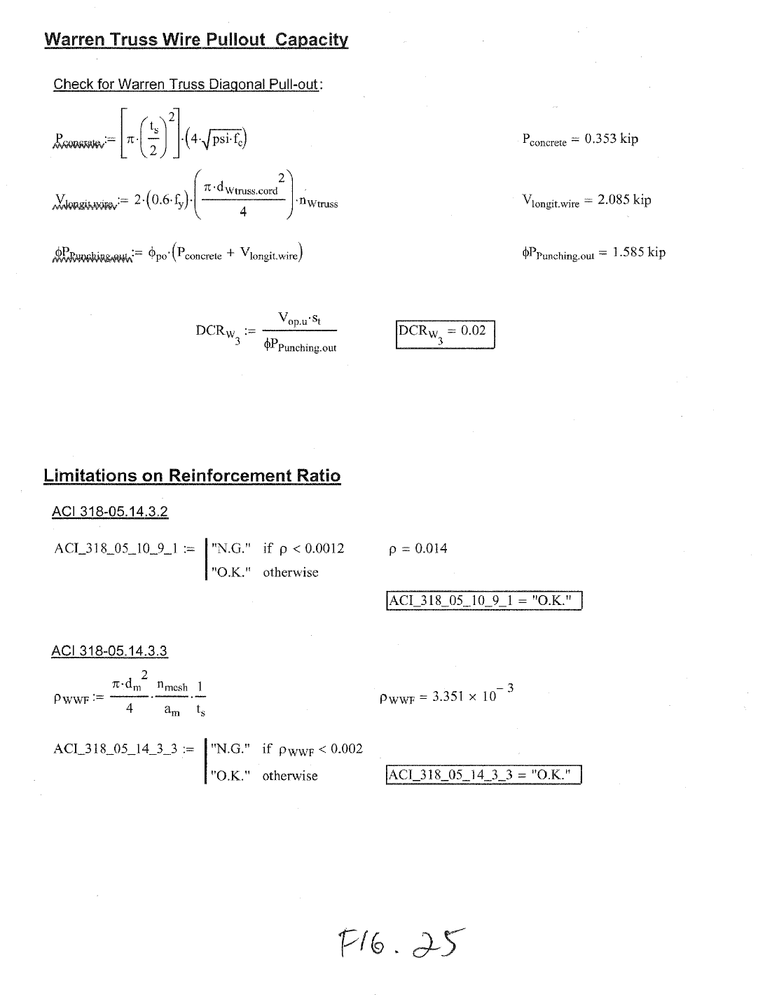

Referring now to FIG. 4, a first truss system 44 is illustrated. A ladder truss member 30 is provided that has a pair of spaced-apart elongated parallel first ladder truss bars and a plurality of spaced-apart elongated second ladder bars extending therebetween in perpendicular relationship to the first ladder truss bars to form a ladder configuration. A warren truss member 46 is provided that has a pair of spaced-apart elongated parallel first warren truss bars 54 and 56 and a second warren truss bar 58 extending at an angle “a” therebetween in a zigzag configuration. Preferably, the angle “a” is between 40 and 50 degrees. Even more preferably, the angle “a” is 45 degrees. The ladder and warren truss members 30 and 46 are superimposed upon each other and attachable to a portion of the structural panel 10 such that the second ladder truss bars 20 intersect the second warren truss bars 58 to form a unitary composite structural panel. Preferably, the ladder and warren truss members 30 and 46 are superimposed upon each other along the first ladder truss bars 16 and 18 and the first warren truss bars 54 and 56 respectively so as to align the first ladder truss bars 16 and 18 and the first warren truss bars 54 and 56 in parallel relationship.

Preferably, a plurality of retainer clips (not shown) engage the first ladder truss bars 16 and 18 and the first warren truss bars 54 and 58. Such clips may be “C” clips or others which may be appreciated by one of ordinary skill in the art. Preferably, the bars 16, 18, 54 and 58 are fabricated from steel.

Referring now to FIG. 5, a second truss system 52 is illustrated that is identical to the first truss system 44 described above but adds the additional element of a second warren truss member 48. In this respect, the ladder truss member 30, the first warren truss member 46, the second warren truss member 48 are superimposed upon each other such that the second warren truss member 48 is inverted and is a mirror-image of the first warrant truss member 46. This has the advantage of providing further strengthening to the connection between the shells 202 and 204 when attached thereto.

A typical warren truss is that which is manufactured by DUR-O-WAL® of Aurora, Ill. Specifically, the DA3100 Truss is commercially available in several forms including those which conform to ASTM A82 (uncoated), ASTM A641 (0.10 oz zinc coating), ASTM A641-Class 1 (0.35 oz zinc coating), ATMA641-Class3 (0.90 oz zinc coating), and ASTM 163-Class B-2 (1.50 oz zinc coating). These trusses are available having a rod which is formed in a zigzag configuration between two parallel rods with an angle of approximately 30 degrees. While it is recognized that other angles, including 45 degrees, have previously been used for similar types of trusses, such configurations are typically available from commercial suppliers as a special-order item that comes at an additional cost, and was previously considered as an unnecessary cost that did not appear to yield any particular benefits over standard warren trusses manufactured having 30 degree angles.

It has been discovered that manufacturing the warren truss having an angle in the range of about 40 to 50 degrees provides the optimum configuration when attached to SCIP panels. Such an angle provides for relatively equal resistance to loads from each direction.

As shown in FIG. 5, in a second embodiment of the present invention, the ladder truss member may be superimposed upon the first warren truss member and the second warren truss member. Preferably, the second warren truss member is inverted (flipped) and is configured having a mirror-image of the first warren truss member.

In the typical warren truss configuration, the following engineering formulas illustrate the design for out-of-plane loading:

$${V}_{s} = \frac{{π}^{3} {dlE}_{s} {D}_{b}^{4}}{4 {s ( {b}^{2} + 4 {d}^{2} )}^{\frac{3}{2}}}$$

In the improved stiffened truss made according to the present invention that combines a ladder truss member with a warren truss member,

$${V}_{s} = \frac{l}{s} min ( {P}_{stud} , \frac{π {D}_{b}^{2}}{4} {f}_{y} sin α )$$

the following engineering formulas illustrate the design for out-of-plane loading:

$${↑ {P}_{stud} / 2 ↓ {P}_{stud} ↑ {P}_{stud} / 2}_{{\_}_{t \underline{↕} {P}_{stud} = min ( \frac{{π}^{3} {E}_{s} {D}_{s}^{4}}{16 ( {b}^{2} + 4 {d}^{2} )} , tb \sqrt{{f}_{c}^{′}} , \frac{{bt}^{2}}{2 s} \sqrt{{f}_{c}^{′}} )}}$$

In the improved stiffened truss made according to the present invention that combines a ladder truss with both the first and second warren trusses, the following engineering formulas illustrate the design for out-of-plane loading:

$${V}_{s} = \frac{l}{s} min [ \frac{{π}^{3} {E}_{s} {D}_{s}^{4}}{16 ( {b}^{2} + 4 {d}^{2} )} , \frac{π {D}_{b}^{2}}{4} {f}_{y} sin α ]$$

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A stiffened truss member for a structural panel having a pair of wire-mesh panels connected to and separated by an insulating material extending therebetween, the stiffened truss member comprising:
a ladder truss member having a pair of spaced-apart elongated parallel first ladder truss bars and a plurality of spaced-apart elongated second ladder bars extending therebetween in perpendicular relationship to the first ladder truss bars to form a ladder configuration;
a warren truss member having a pair of spaced-apart elongated parallel first warren truss bars and a second warren truss bar extending at an angle therebetween in a zigzag configuration; and
wherein the ladder and warren truss members are superimposed upon each other and being attachable to a portion of the structural panel such that the second ladder truss bars intersect the second warren truss bars to form a unitary composite structural panel.

2. The stiffened truss member as in claim 1 wherein the ladder and warren truss members are superimposed upon each other along the first ladder truss bars and the first warren truss bars respectively so to align the first ladder truss bars and the first warren truss bars in parallel relationship.

3. The stiffened truss member as in claim 2 wherein the ladder and warren truss members are attached to each other via a plurality of retainer clips disposed at locations along the first ladder truss bars and the first warren truss bars.

4. The stiffened truss member as in claim 1 wherein the angle is in the range of between 40 to 50 degrees.

5. The stiffened truss member as in claim 4 wherein the angle is exactly 45 degrees.

6. The stiffened truss member as in claim 1 wherein the first ladder truss bars, the second ladder truss bars, the first warren truss bars, and the second warren truss bars are fabricated from a rigid material of a uniform thickness.

7. The stiffened truss member as in claim 6 wherein the first ladder truss bars, the second ladder truss bars, the first warren truss bars, and the second warren truss bars are fabricated from steel.

8. A stiffened truss member for a structural panel having a pair of wire-mesh panels connected to and separated by an insulating material extending therebetween, the stiffened truss member comprising:
a ladder truss member having a pair of elongated parallel first ladder truss bars and a plurality of elongated second ladder bars extending therebetween in perpendicular relationship to the first ladder truss bars to form a ladder configuration;
first and second warren truss members each having a pair of elongated parallel first warren truss bars and a second warren truss bar extending at an angle therebetween in a zigzag configuration; and
wherein the first warren truss member is inverted and superimposed upon the first and second warren truss members and being attachable to a portion of the structural panel such that the second ladder truss bars intersect the second warren truss bars of both the first and second warren truss members to form a unitary composite structural panel.

9. The stiffened truss member as in claim 8 wherein the ladder truss member, the first warren truss member and the second warren truss member are superimposed upon each other along the first ladder truss bars, the first warren truss bars of the first warren truss member, and the first warren truss bar of the second warren truss member respectively so to align the first ladder truss bars, the first warren truss bars of the first warren truss member, and the first warren truss bars of the second warren truss member in parallel relationship.

10. The stiffened truss member as in claim 9 wherein the ladder truss member, the first warren truss member and the second warren truss member are attached to each other via a plurality of retainer clips disposed at locations along the first ladder truss bars, the first warren truss bars of the first warren truss member, and the first warren truss bars of the second warren truss member.

11. The stiffened truss member as in claim 9 wherein the angle is in the range of between 40 to 50 degrees.

12. The stiffened truss member as in claim 11 wherein the angle is exactly 45 degrees.

13. The stiffened truss member as in claim 9 wherein the first ladder truss bars, the second ladder truss bars, the first warren truss bars of both the first and second warren truss members, and the second warren truss bars of both the first and second warren truss members are fabricated from a rigid material of a uniform thickness.

14. The stiffened truss member as in claim 13 wherein the first ladder truss bars, the second ladder truss bars, the first warren truss bars of both the first and second warren truss members, and the second warren truss bars of both the first and second warren truss members are fabricated from steel.

15. A stiffened truss member for a structural panel having a pair of wire-mesh panels connected to and separated by an insulating material extending therebetween, the stiffened truss member comprising:
a pair of elongated parallel combined truss bars and a plurality of elongated ladder bars extending therebetween in perpendicular relationship to the combined truss bars to form a ladder configuration;
an elongated zigzag bar extending between the combined truss bars at an angle in a zigzag configuration; and
wherein the ladder bars and the zigzag bars intersect each other at spaced-intervals along the combined truss bars and being attachable to a portion of the structural panel to form a unitary composite structural panel.

16. A method of producing an engineered composite structural panel comprising the steps of:
(a) selecting a structural panel having at least two structural shells, an insulating material extending therebetween, and a plurality of truss members extending therebetween;
(b) determining if the two or more structural shells act as a unitary composite structural panel; and
(c) if the structural panel is not a unitary composite structural panel, then adjusting parameters of the panel and repeating step (b).

17. The method as in claim 16 wherein step (b) comprises the step of calculating the buckling capacity of the shells such that P_{Global}>P_{Local} and V_{Truss}>Vᵤ.

18. The method as in claim 17 further comprising the step of:
(d) determining capacity of each of the structural shells.

19. The method as in claim 18 further comprising the step of:
(e) determining limit state of the panel by calculating a plurality of force and eccentricity pairs such that at least one of the shells exceeds the capacity calculated in step (d).

20. The method as in claim 19 further comprising the step of:
(f) if the structural panel is a unitary composite structural panel, then checking shear capacity of the truss according to the formula V_{Truss}>Vᵤ.

21. The method as in claim 20 further comprising the step of:
(g) if the structural panel works as unitary composite panel, then verifying connectivity between the truss members and structural shells such that all shear load is taken by truss members.

22. The method as in claim 21 wherein step (g) further comprises the step of:
(1) verifying the pullout capacity of the unitary composite panel; and
(2) verifying the punching shear capacity of the unitary composite panel.

23. The method as in claim 16 wherein at least three structural shells are selected in step (a) and further comprising the step of determining stress-strain for capacity of the unitary composite structural panel.

24. The method as in claim 16 wherein the parameters are selected from the group consisting of: spacing between the truss members, number of truss members, thickness of truss members, thickness of shells, and distance between shells.

25. The method as in claim 16 wherein step (a) comprises the steps of:
1) selecting loads to be carried by the panel; and
2) selecting parameters of panels.

26. The method as in claim 16 wherein step (a) further comprises the step of:
attaching a stiffened truss member for a structural panel having a pair of wire-mesh panels connected to and separated by an insulating material extending therebetween, the stiffened truss member comprising:
a ladder truss member having a pair of spaced-apart elongated parallel first ladder truss bars and a plurality of spaced-apart elongated second ladder bars extending therebetween in perpendicular relationship to the first ladder truss bars to form a ladder configuration;
a warren truss member having a pair of spaced-apart elongated parallel first warren truss bars and a second warren truss bar extending at an angle therebetween in a zigzag configuration; and
wherein the ladder and warren truss members are superimposed upon each other and being attachable to a portion of the structural panel such that the second ladder truss bars intersect the second warren truss bars to form a unitary composite structural panel.

27. The method as in claim 16 wherein step (a) further comprises the step of:
attaching a stiffened truss member for a structural panel having a pair of wire-mesh panels connected to and separated by an insulating material extending therebetween, the stiffened truss member comprising:
a ladder truss member having a pair of elongated parallel first ladder truss bars and a plurality of elongated second ladder bars extending therebetween in perpendicular relationship to the first ladder truss bars to form a ladder configuration;
first and second warren truss members each having a pair of elongated parallel first warren truss bars and a second warren truss bar extending at an angle therebetween in a zigzag configuration; and
wherein the first warren truss member is inverted and superimposed upon the first and second warren truss members and being attachable to a portion of the structural panel such that the second ladder truss bars intersect the second warren truss bars of both the first and second warren truss members to form a unitary composite structural panel.

28. The method as in claim 16 wherein step (a) further comprises the step of:
attaching a stiffened truss member for a structural panel having a pair of wire-mesh panels connected to and separated by an insulating material extending therebetween, the stiffened truss member comprising:
a pair of elongated parallel combined truss bars and a plurality of elongated ladder bars extending therebetween in perpendicular relationship to the combined truss bars to form a ladder configuration;
an elongated zigzag bar extending between the combined truss bars at an angle in a zigzag configuration; and
wherein the ladder bars and the zigzag bars intersect each other at spaced-intervals along the combined truss bars and being attachable to a portion of the structural panel to form a unitary composite structural panel.
